(19) United States
(12) Patent Application Publication
(10) Pub. No.: US 2022/0106940 A1
(43) Pub. Date: Apr. 7, 2022

(54) METHOD FOR CONTROLLING A WIND POWER INSTALLATION

(71) Applicant: Wobben Properties GmbH, Aurich (DE)

(72) Inventor: Menko Bakker, Aurich (DE)

(21) Appl. No.: 17/492,243

(22) Filed: Oct. 1, 2021

(30) Foreign Application Priority Data
Oct. 2, 2020 (EP) 20199929.9

(51) Int. Cl. F03D 9/25; H02J 3/38

(52) U.S. Cl. CPC F03D 9/25; F05D 2220/762; H02J 2300/28; H02J 3/381

(57) ABSTRACT

Provided is a method for controlling a wind power installation. The wind power installation includes a generator for generating a generator current with one or more generator current phases, and an active rectifier for rectifying and controlling the generator current. For each generator current phase the rectifier has a plurality of controllable sub-rectifiers. Each controllable sub-rectifier is characterized by a partial inductance, each controllable sub-rectifier controls a partial current of the generator current phase and each generator current phase forms a summation current as a sum of all the partial currents of the relevant generator current phase. The active rectifier is controlled so that for each generator current phase the summation current is detected and each controllable sub-rectifier of the relevant current phase controls the partial current thereof depending on the detected summation current.

### BACKGROUND

### Technical Field

The present invention relates to a method for controlling a wind power installation and the invention relates to a corresponding wind power installation.

### Description of the Related Art

Wind power installations are known, and these generate electrical power from wind by means of a generator and feed same into an electrical supply network. A common topology of such a wind power installation operates in such a way that the generator generates an alternating current, this alternating current is rectified and from this rectified current, which is usually provided in this case in a DC link, the alternating current to be fed in is generated by means of an inverter.

Modern wind power installations are characterized by a rated power of several megawatts (MW). In order to rectify such a power generated by a generator, several rectifiers can be connected in parallel. If these rectifiers are actively controlled and hence also actively control the corresponding generator current that they rectify, it is also possible to speak of generator-side inverters. These can, at least in theory, be structurally identical to the inverters that generate the alternating current to be fed into the electrical supply network. To avoid confusion, the designation active rectifier may be useful in this respect for the generator-side inverter and constitutes a synonym.

Passive inverters, which thus operate as diode rectifiers, have conventionally been used for the purpose of inverting. In the three-phase case, these diode rectifiers can also be referred to as what are known as B6 bridges or as B6 bridge rectifiers.

As a technical improvement, in particular to improve a targeted actuation of the generator and thus overall for an improvement in the control of the generator, it is expedient or even necessary to use the mentioned active rectifiers or generator-side inverters.

In this case, too, several inverters can be connected in parallel. This can achieve a situation in which more cost-effective inverters can be used. This also makes it possible to use the same inverters, but depending on the power of the generator to connect a different number of inverters in parallel, for different sizes of generators, that is to say different generator powers. Each inverter then forms a sub-inverter.

In order to distribute each phase of the current to be rectified, that is to say the generator current, across the sub-inverters in a uniform manner when such generator-side sub-inverters are connected in parallel, a corresponding fraction of the generator current of the relevant phase to be controlled can be prescribed as setpoint current for each sub-inverter. If three sub-inverters are provided, for example, each sub-inverter can control a third of the generator current and receive a corresponding setpoint value for this, that is to say in each case receive a third of the overall setpoint current as setpoint value.

However, these sub-inverters are connected on the generator side on account of the parallel connection thereof. Furthermore, they can likewise be connected via a common DC link. This results in the risk of circulating currents arising.

Such circulating currents can be kept low by way of sufficient inductances of the generator-side inverters. Appropriate inductances, which connect individual DC links of the sub-inverters, can also keep such circulating currents low.

The problem of the circulating currents can in this case arise particularly with inverters that carry out current control using a hysteresis method. With such a hysteresis method, a tolerance band with an upper and lower band limit is prescribed for the alternating current that is to be controlled. If the generated current reaches one of the band limits, switching accordingly takes place in order to keep the current in the tolerance band. In the case of circulating currents, the problem then arises that, in each sub-inverter, the detected partial current that is intended to be guided there in the prescribed tolerance band can have components of a circulating current. This can thus disadvantageously influence the current control.

However, such inductances may be undesirable, in particular because they may be a costly component.

In the European priority application, the European Patent Office searched the following prior art: DE 10 2014 219 052 A1 and JP 2001314086 A.

### BRIEF SUMMARY

As provided herein, a parallel connection of inverters is made possible with a low inductance on the generator side, in particular a parallel connection of inverters with a hysteresis method for current control. In particular, in one or more embodiments, undesired circulating currents are prevented.

A method is provided. This method therefore relates to controlling a wind power installation having a generator for generating a generator current with one or more generator current phases. In particular, it has a generator having three generator current phases or six generator current phases. In the case of six generator current phases, these are formed in particular as two three-phase current phases.

Furthermore, an active rectifier for rectifying and controlling the generator current is provided. The active rectifier can also be referred to synonymously as a generator-based inverter since it not only rectifies but also controls the generator current, namely in a targeted manner. In particular, specifically a setpoint current according to magnitude, frequency and phase is prescribed here for the generator current. In particular, a synchronous generator is used as generator and a stator current of the generator is controlled as generator current.

For each generator current phase the active rectifier has a plurality of controllable sub-rectifiers. The controllable sub-rectifiers can also be referred to as controllable generator-based sub-inverters. Each controllable sub-rectifier is characterized by a partial inductance. For this purpose, an inductive component can be provided, but said partial inductance can also result only or additionally from the specific structure of the sub-rectifier, including necessary connection line.

Each controllable sub-rectifier controls a partial current of the generator current phase and each generator current phase forms a summation current as a sum of all the partial currents of the relevant generator current phase. For example, three controllable sub-rectifiers can be provided for each phase. Each of said three controllable sub-rectifiers controls a partial current, with the result that three partial currents are controlled. These three partial currents are added together to form the summation current.

Provision is now made for the active rectifier to be controlled so that for each generator current phase the summation current is detected and each controllable sub-rectifier of the relevant current phase controls the partial current thereof depending on the detected summation current.

The detection of the summation current can be provided in particular so that each partial current is measured and the summation current is composed of said measured partial currents by way of calculation. This has the particular advantage that current measurements performed at the sub-rectifiers can be used for this purpose. A sensor for the total current is then superfluous.

Each controllable sub-rectifier of the relevant current phase now controls the partial current thereof depending on the summation current detected thereby. In particular, each controllable sub-rectifier is thus operated by the detected summation current instead of by the partial current thereof.

In particular, the type of control in which each sub-rectifier provides an individual control loop that controls the partial current thereof, that is to say the actual value of the partial current, to a setpoint value for partial current thereof is abandoned. In particular, a control principle in which the desired summation current, that is to say the desired generator current of the relevant phase, is divided into individual partial current setpoint values and each of these partial current setpoint values is controlled by a sub-rectifier is abandoned. Instead, a summation current setpoint value is prescribed only for the provided summation current, that is to say for the provided generator current of the relevant phase, and each individual sub-rectifier is actuated depending on how the detected summation current behaves in relation to the prescribed summation current setpoint value in order thereby to then control the detected summation current overall. In particular, it is therefore proposed that no setpoint value is prescribed for each sub-rectifier.

In this case, it has been identified in particular that the consideration of the summation current prevents circulating currents disadvantageously influencing the individual control in each individual sub-rectifier. Each individual sub-rectifier can also be referred to as a sub-rectifier with local control and the proposed solution thus prevents circulating currents from influencing the local control. That is to say the summation current does not include the circulating currents.

In accordance with one embodiment, it is proposed that the active rectifier operates according to a hysteresis method, wherein a tolerance band with an upper and a lower band limit is prescribed for each summation current and each sub-rectifier controls the partial current thereof depending on whether the summation current reaches the upper or lower band limit.

A conventional tolerance band method makes provision for there to be a check for the respective current to be controlled to determine whether it reaches a band limit and then, if the band limit is reached, switching accordingly takes place. In previous methods, this has been implemented for the sub-rectifiers in such a way that they each generate a partial current and for this partial current check whether it is in the tolerance band prescribed for it. Switching would thus take place when this partial current reaches an upper or lower band limit of the tolerance band thereof. This variant is not used here.

Instead, provision is made for each sub-rectifier to still perform appropriate switching processes in order to control the current and thus also to control the partial current thereof. However, the trigger is now no longer whether the partial current reaches one of the band limits thereof but whether the summation current reaches a band limit Each of the sub-rectifiers whose partial currents combine to form the considered summation current then switches in a manner depending thereon. In this respect, the reaching of a band limit by the detected summation current is communicated to all sub-rectifiers, which then all react accordingly in a manner depending thereon.

Provision is made in particular for each sub-rectifier to have at least one switching device in order to control the partial current thereof by way of switching the switching device and the switching of the switching device to be controlled depending on whether the summation current reaches the upper or lower band limit.

In this case, the summation current is thus monitored centrally to determine whether it reaches a band limit and, if this is the case, appropriate switching then takes place, however, individually by each sub-rectifier. The individual partial currents are thus furthermore generated by the sub-rectifiers, also through switching of the switching devices. However, the triggering of these switching processes is controlled centrally by the monitoring of the summation current in the tolerance band for the summation current.

It is thus possible to use a hysteresis method, which can also be referred to as a tolerance band method, and which for each generator current phase connects several sub-rectifiers in parallel and is insusceptible to circulating currents. The partial inductances can also be dimensioned to be small for this purpose, if they are provided at all as separate components. In particular, such partial inductances if present can be used for other tasks or can be dimensioned for other tasks, in particular for a filter function. Small partial inductances, which thus lead to a reduction in costs compared to greater partial inductances, can be provided.

In accordance with one embodiment, provision is made for each sub-rectifier to be assigned an individual delay time, and each sub-rectifier to control the partial current thereof additionally depending on said individual delay time. The assignment of this individual delay time is carried out based in particular on the physical conditions. In particular, an actually active delay time is determined for each sub-rectifier and assigned as individual delay time. The individual delay time can depend for example on line lengths or can vary based on manufacturing tolerances of the components. However, it is also taken into consideration that the individual delay time is set deliberately to certain values in order to influence the control as a result.

Provision is made here in particular for each sub-rectifier to switch at least one of the switching device thereof, after the summation current has reached the upper or lower band limit and the individual delay time has elapsed. This also achieves a situation in which the sub-rectifiers of the relevant phase are not switched on in an exactly synchronous manner even though, however, they are all switched depending on when the summation current has reached the upper or lower band limit.

An individual delay time in this case also denotes in particular the time that passes until a switching process of the sub-rectifier has a significant effect on the summation current. For example, the individual delay time can be the time that passes after the sub-rectifier has been switched until the current generated thereby reaches the considered summation current at least with a value of 63%. Such behavior can be identified for example by a test signal, by virtue of the effect of a specifically prescribed switching signal being detected and being set in relation to this switching signal.

It is preferably proposed that the delay time, that is to say the individual delay time, is determined in each case depending on the partial inductance of the sub-rectifier. This partial inductance influences how long a partial current generated by a switching process or how long a change in the partial current generated by the switching process is required until it has become effective at the summation current. As described, in this case a 63% effectiveness can be taken as a basis instead of a 100% effectiveness. In this respect, the individual time constant would be defined here as the time constant of a delay element of the first order.

In accordance with one embodiment, it is proposed that a deviation of each partial current from an average partial current is detected, and the sub-rectifier is controlled, in particular the individual delay time is determined, depending on the deviation.

Each sub-rectifier generates a partial current and all partial currents are combined to form the summation current. If three sub-rectifiers are provided, for example, the average partial current corresponds to a third of the summation current. In the ideal case, each partial current corresponds to the average partial current. In the example mentioned, each of the three sub-rectifiers would generate a third of the summation current in the ideal case mentioned. However, these partial currents can differ on account of individual deviation, in particular on account of different line lengths and component variances. And this difference can be detected through comparison with the average partial current. And the difference detected in this way can be used to determine the individual delay time. In particular, namely such a difference in the partial currents is mirrored in a corresponding temporal deviation from the average partial current.

In accordance with one embodiment, it is proposed that, depending on a sub-rectifier voltage and depending on a current profile associated with the sub-rectifier voltage and depending on a generator inductance of the generator, a dynamic correlation between a switching process of a sub-rectifier and a resulting partial current is established. And for this purpose it is proposed that the sub-rectifier is controlled depending on this dynamic correlation and depending on the detected summation current.

Such a dynamic correlation between a switching process of a sub-rectifier and a resulting partial current can particularly be a dynamic correlation, that is to say an underlying dynamic that characterizes a step response. The dynamic correlation can be denoted as a transmission function or be specified as a transmission function, in particular in terms of control technology. Wherein, in the case of such an explanation, it should be noted that a step response, or the appropriate input step, is assumed mostly in an idealizing manner. A switching process is particularly the opening or closing of a semiconductor switch of the sub-rectifier. The sub-rectifier voltage assumed for the differential equation can then execute a step in an idealizing manner, whether it be from zero to a voltage value or from a voltage value to zero.

To stay with this illustrative description that is conventional in control technology, such a step response is also influenced by the generator inductance and additionally by a property of the sub-rectifier, in particular by the partial inductance of the sub-rectifier under consideration. For this basic correlation, a differential equation can be set, which describes these properties in principle. However, specific values, or at least one specific value, namely conditional on the partial inductance, may be unknown. The differential equation involves a voltage, which does not need to be detected, however, but instead is used only to form the differential equation. The differential equation can be solved by obtaining the unknown property. This unknown property can be taken into account in the differential equation as a time constant. This time constant is then determined according to its value by solving the differential equation. The differential equation is thus solved in order to determine at least one previously unknown parameter, particularly a previously unknown time constant.

This dynamic correlation can thus be described by the differential equation in principle, and can also be stipulated quantitatively through detection of a respective current profile.

The result is thus the dynamic correlation, which is also known quantitatively, that is to say particularly the transmission function. The sub-rectifier is then controlled depending on this dynamic correlation and depending on the detected summation current. The control depending on the detected summation current can thus be carried out as has been described above with respect to other embodiments.

Therefore, it is proposed in particular that the delay time, that is to say the specific delay time of the sub-rectifier under consideration, is determined depending on this dynamic correlation. The sub-rectifier is then controlled depending on the delay time determined in this way. The switching processes thereof are namely controlled in a manner depending thereon.

The voltage detected at the sub-rectifier is in particular the output voltage at the sub-rectifier of the relevant phase. A sub-rectifier voltage at the output of the sub-rectifier then leads to a current profile, namely particularly conditional on the partial inductance and the generator inductance. This correlation is described by the differential equation or by a differential equation system and in it a respective current profile is assigned to a voltage profile, particularly a voltage step.

The following example provides an exemplary explanation.

For the selected example, a partial inductance can be present and denoted as L_GR_d, wherein the value thereof may be L_GR_d=100 microhenry (μH)/converter unit, that is to say 100 μH/sub-rectifier. In this case, in this example 7 sub-rectifiers can be interconnected to form one rectifier. The generator can then in turn be an inductance of 10 mH/sub-generator system, for an example in which 4 sub-generator systems are interconnected to form one generator system. In the case of 7 active rectifiers, an effective inductance of 100 μH/7 thus arises compared to a generator inductance of 10 mH/4. The time constant of the change in current in the generator therefore permits the aforementioned correlation of the inductances.

In the transient transition, the behavior of the 7 converters among one another is thus relevant. If for example 6 sub-rectifiers, which can also be referred to as converters, carry an identical partial current of 100 amperes (A) and the 7th sub-rectifier carries only 93 A. The preliminary state is that all switching elements are switched on and the upper summation limit is infringed; the target state is thus that all switching elements are off. The target is now to eliminate the differences in the transition so that the sum

6*100 A+1*93 A=693 by 7*99 A=693 A

is reached again.

Through the approach of switching on the rectifiers in the form of 6*OFF and 1*ON for a certain time, the result is an inductive series circuit of 100 μH+100 μH/6=116 μH, via which the now full link voltage Vzw (for example 1160V) is applied.

In this overall inductance, a change in current of 6 A (93 A+6 A=99 A) now has to be brought about Ideally, the following applies here

Vzw=L*di/dt

->dt=L/Vzw*di=116 μH/1160V*6 A=6.0000e-07 seconds (s)=600 nanosecond (ns)

This is an illustrative example, which can be formed as desired for other states. In particular when the currents are not as similar as in this illustrative example, up to 6 temporarily applicable equations can result in the transition when 7 sub-rectifiers are present or are taken into consideration. Likewise, the direction of the switching process is relevant; in the above example, the voltage during switch-on would have to be selected accordingly so that switch-on takes place earlier. This may be relevant in particular for the input of proportional-integral (PI) controllers for feed forward control.

In accordance with one configuration, it is proposed that a central control system detects the summation current, generates control signals for the sub-rectifiers and transmits same to the sub-rectifiers in order to control the sub-rectifiers. Provision is thus made of a central control system that controls the sub-rectifiers depending on the summation current and for this purpose generates corresponding control signals and transmits same to the sub-rectifiers.

In particular, individual switching time adjustments are determined for the sub-rectifiers. The switching times are important for the sub-rectifiers in order to generate the desired partial current. In order to generate the desired partial current depending on the detected summation current with each sub-rectifier, these individual switching time adjustments are provided. These switching time adjustments can include the individual delay time and also take into account signal propagation times.

Provision is optionally made for these switching time adjustments to be transmitted to the sub-rectifiers, in particular by way of the central control system. However, consideration is also given to the fact that the switching time adjustments are taken into account in the central control system.

In particular, provision is made for propagation times for the transmission of control signals of the central control system to the respective rectifier to be determined and taken into account in the determination of the switching time adjustments. It has been identified that through the communication a time-discrete clock of 1 microsecond (μs) (clock time) is technically reasonable to achieve, wherein the times to be controlled may be below this clock time. Consideration is also given to the fact that this clock time is also sometimes smaller, however, than technically realizable times. Therefore, although the time to be adjusted respectively, that is to say the respective switching time adjustments, would be calculated centrally, it would preferably be communicated with the vector to be implemented on the local side. In this embodiment, that is to say all switching time adjustments are bundled in the vector to be implemented and transmitted together, with the result that different propagation times are prevented as a result.

It has thus been identified that not only individual delay times, which relate to physical delays between the respective switching time of the sub-rectifier and becoming active in the summation current, may be relevant, but also that the transmission of control signals from the central control system to each sub-rectifier is to be taken into account. This may mean that such transmission times between the central control system and each sub-rectifier are identical or deviations can be disregarded; however, it may also mean that differences that cannot be disregarded exist. This can also depend on the selected type of transmission. It is preferably proposed to determine such propagation times individually between the central control system and each sub-rectifier when they are not transmitted together, in particular in a common vector.

In particular, it is proposed that, when the switching time adjustments are determined, the individual delay times of the sub-rectifiers and/or the propagation times for the transmission of information from the central control system to the respective sub-rectifier are stored in a control protocol and used to control the sub-rectifiers.

One control option is that the central control system sends a central identical control signal to all sub-rectifiers relating to a phase and then each sub-rectifier adjusts the switching time thereof depending on the individual switching time adjustment thereof. The sub-rectifier then takes into account in particular itself the individual delay time thereof and the propagation time, relevant thereto, for the transmission of information from the central control system to it.

In this case, it is preferably proposed to determine, in particular to measure, the individual delay times in advance. To this end, an initial measurement before start-up of the rectifier can be performed, which is proposed here as one embodiment.

With the proposed storing of the individual delay times and/or the propagation times in the control protocol, a variant in which the central control system takes into account these individual times of each sub-rectifier is proposed. For the purpose of actuation, the summation current is then monitored by the central control system. However, this can be done in such a way that the central control system for this purpose obtains the values of each partial current from the sub-rectifiers.

If the detected summation current then reaches a band limit, the sub-rectifiers are actuated individually by the central control system for the purpose of switching. This can be done in such a way that the central control system takes into account the switching time adjustment of each sub-rectifier, in particular thus individually takes into account the individual delay time and the propagation time for the transmission of information for each sub-rectifier. Based on this, a control signal, that is to say a switching command, can then be sent from the central control system to each sub-rectifier at individual times. Each switching command sent by the central control system is then coordinated precisely in terms of time so that the respectively actuated sub-rectifier then switches at the right time.

In accordance with one embodiment, a control structure, which provides star-shaped communication with central clock, is proposed. The communication can be structured in such a way that a constant delay time with a low degree of fluctuation, for example of a maximum of 10 ns (maximum jitter of 10 ns), is achieved.

In accordance with this embodiment, the switching signals with the delay that is equal for all can thus be transmitted to all sub-rectifiers at the same time.

The propagation times mentioned can be caused particularly by electrical/optical/electrical conversion and/or by a driver stage, namely in particular a gate resistance and a gate capacitance.

In accordance with one embodiment, it is proposed that each sub-rectifier performs switching processes for generating a voltage pulse, wherein in each case a triggering switching process is provided to trigger a voltage pulse, and a terminating switching process is provided to terminate a voltage pulse, and a time interval between the triggering switching process and the terminating switching process of the voltage pulse describes a pulse width of the voltage pulse, wherein different switching time adjustments and different and in particular variable delay times are provided for the triggering switching process and the terminating switching process in order to control the pulse width as a result.

The partial current to be generated in each sub-rectifier depends in particular on the voltage pulse and the partial inductance, in addition on a generator inductance. In order to increase the partial current of a first sub-rectifier compared to the partial current of a second sub-rectifier, this can be done by virtue of the voltage pulse being widened. This can be achieved by the appropriate selection of the switching time adjustments or delay times of the triggering and terminating switching processes. In order to make the voltage pulse wider, the triggering switching process can be brought forward in terms of time, that is to say can be less delayed, and/or the terminating switching process can be pushed backward in terms of time, that is to say can be more delayed.

The voltage pulses can be positive or negative. The triggering switching process can thus trigger a rising or falling voltage edge and the terminating switching process can accordingly trigger a falling or rising edge and thereby terminate the positive voltage pulse or the negative voltage pulse.

In particular, the pulse width can be lengthened or shortened as a result thereof. The original width can result in this case from a tolerance band controller, which is proposed in this case generally, namely as a current controller in each sub-rectifier. The interventions that change this width exist in a temporal behavior, such that the extension of the pulse width is not relevant to the overall length of the actuation. The basic behavior of the tolerance band controller is thus not changed; only individual switchover times are changed.

In accordance with one embodiment, it is proposed that in each case three sub-rectifier arrangements, namely in each case a sub-rectifier arrangement of a first, second and third generator current phase, together with a network-based sub-inverter arrangement form a back-to-back sub-converter. Each back-to-back sub-converter has a common DC link to which the sub-rectifiers of a respective sub-rectifier arrangement rectify and from which the sub-inverter arrangement inverts. To this end, it is further proposed that the DC links of a plurality of back-to-back sub-converters are coupled in order to permit circulating currents via said coupled DC links.

It has been identified here in particular that no circulating currents are intended to be intentionally controlled in the context of the method. The method operates in such a manner that it controls or prevents the circulating currents to the greatest possible extent. However, it has been recognized that it is possible in particular in the calculation of the switching time adjustments to take into account the fact that in particular on the network side intended circulating currents are not compensated for. They can then arise as equalization currents between the phases and accordingly be permitted.

A wind power installation is also proposed and said wind power installation comprises
a generator for generating a generator current with one or more generator current phases, and
an active rectifier for rectifying and controlling the generator current, wherein for each generator current phase the rectifier
has a plurality of controllable sub-rectifiers,
each controllable sub-rectifier is characterized by a partial inductance, and
each controllable sub-rectifier controls a partial current of the generator current phase and each generator current phase forms a summation current as a sum of all the partial currents of the relevant generator current phase, wherein
the wind power installation has a control unit (e.g., controller) for controlling the active rectifier, and wherein the control unit is set up in such a way that
the active rectifier is controlled so that for each generator current phase
the summation current is detected and
each controllable sub-rectifier of the relevant current phase controls the partial current thereof depending on the detected summation current.

The wind power installation thus has a control unit for controlling the active rectifier. The control unit is set up to control the active rectifier so that for each generator current phase the summation current is detected and each controllable sub-rectifier of the relevant current phase controls a partial current depending on the detected summation current. In particular, the control unit can be set up for this control by virtue of a corresponding sequence being implemented in the control unit as a sequence code or sequence program. Furthermore, the control unit has corresponding interfaces in order to detect the summation current. To this end, it can detect the partial currents of each sub-rectifier and determine the summation current therefrom. The detection of the partial currents can be prepared so that the control unit obtains respective values from the sub-rectifiers. Corresponding measuring and/or control elements (e.g., ammeters, voltmeters or multimeters) of the individual sub-rectifiers can thus be connected to the control unit or they can be part of the control unit.

In particular, provision is made for the wind power installation, in particular the control unit, to be prepared to carry out a method in accordance with one of the embodiments described above. For this purpose, a corresponding sequence can be implemented in the control unit in particular as a program.

Insofar as the methods use a central control system, this can be part of the control unit.

### BRIEF DESCRIPTION OF THE SEVERAL VIEWS OF THE DRAWINGS

The invention will now be discussed in more detail below by way of example on the basis of exemplary embodiments with reference to the accompanying figures.

FIG. 1 shows a perspective illustration of a wind power installation.

FIG. 2 schematically shows a rectifier of a phase by way of example with three sub-rectifiers.

FIG. 3 schematically shows a structure for controlling a plurality of sub-rectifiers.

### DETAILED DESCRIPTION

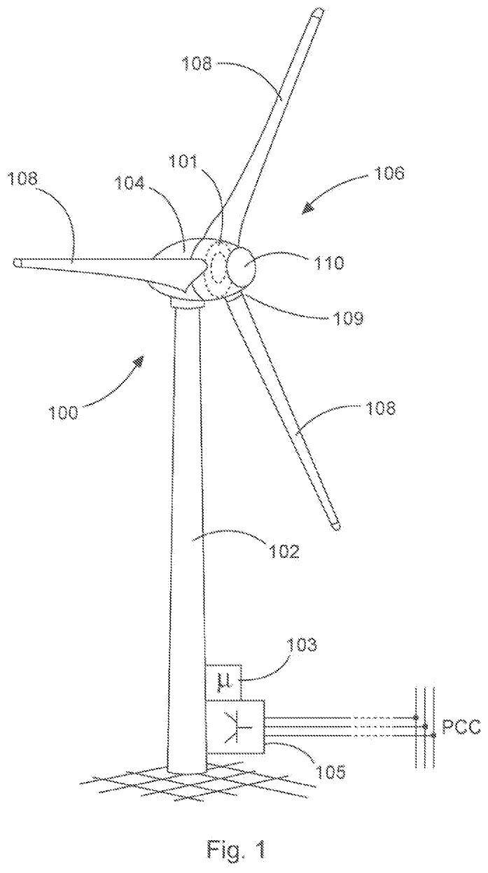

FIG. 1 shows a schematic illustration of a wind power installation. The wind power installation 100 has a tower 102 and a nacelle 104 on the tower 102. An aerodynamic rotor 106 having three rotor blades 108 and having a spinner 110 is provided on the nacelle 104. During the operation of the wind power installation, the aerodynamic rotor 106 is set in rotational motion by the wind and thereby also rotates an electrodynamic rotor or armature of a generator, which is coupled directly or indirectly to the aerodynamic rotor 106. The electric generator is arranged in the nacelle 104 and generates electrical energy. The pitch angles of the rotor blades 108 can be varied by pitch motors at the rotor blade roots 109 of the respective rotor blades 108.

The wind power installation 100 in this case has an electric generator 101, which is indicated in the nacelle 104. Electrical power can be generated by means of the generator 101. An infeed unit 105, which can be designed, in particular, as an inverter, is provided to feed in electrical power. It is thus possible to generate a three-phase infeed current and/or a three-phase infeed voltage according to amplitude, frequency and phase, for infeed at a network connection point PCC. This can be effected directly or else jointly with further wind power installations in a wind farm. An installation control system (e.g., controller) 103 is provided for controlling the wind power installation 100 and also the infeed unit 105. The installation control system 103 can also acquire predefined values from an external source, in particular from a central farm computer. An active rectifier, which may be part of the infeed unit 105, is connected to the generator 101.

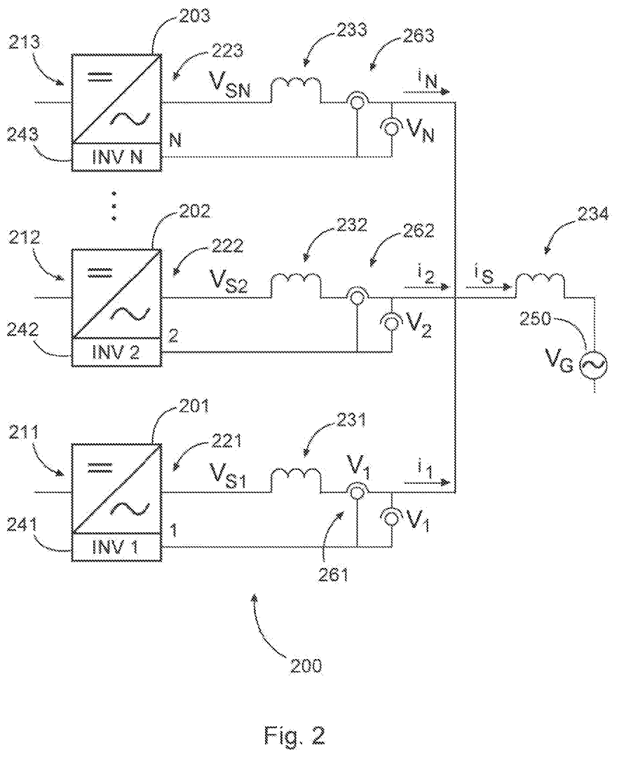

FIG. 2 illustrates a sub-rectifier arrangement 200 of a phase, which comprises a plurality of sub-rectifiers 201-203. A plurality of such sub-rectifier arrangements 200 of a phase can then together form an overall active rectifier, which is then used overall to rectify and control the generator current of a generator of a wind power installation. In this case, however, only one sub-rectifier arrangement of a phase is considered. Corresponding sub-rectifier arrangements are provided for further phases.

The sub-rectifier arrangement 200 of a phase thus has three sub-rectifiers 201-203. The third sub-rectifier 203 as sub-rectifier N can also be representative of all further sub-rectifiers that overall form the sub-rectifier arrangement 200 of a phase.

In FIG. 2, the basic structure of the design of said sub-rectifier arrangement 200 of a phase from a plurality of sub-rectifiers 201-203 is intended to be explained, namely on the generator side. Each sub-rectifier 201-203 may have a DC output 211-213. Each sub-rectifier 201-203 may also be formed as part of a sub-converter arrangement. In this case, a DC link would be provided internally and instead of the DC output 211-213 an AC voltage output would be provided.

Each sub-rectifier 201-203 has a generator-side output 221-223. Furthermore, each sub-rectifier 201-203 has a partial inductance 231-233. Each partial inductance 231-233 is symbolized in FIG. 2 as a component connected to the generator-side output 221-223. However, it is also representative of inductances that can result for example due to the feed line or also takes this into account.

A control part 241-243 is provided to control each sub-rectifier 201-203. The control part can receive control signals and thus control semiconductor switches of the sub-rectifier in order thereby to generate a pulsed voltage signal that is intended to lead to a modulated sinusoidal current A switching voltage V_{S1}, V_{S2} or V_{SN} is produced directly at the generator-side output of the inverter, said switching voltage changing between a positive value, negative value and the value of zero substantially depending on the corresponding switch positions. A generator-side voltage V₁, V₂ and V_{N} and a generator-side current i₁, i₂ and i_{N} is produced at the generator-side output of the partial inductance 231, 232 or 233. Each of said generator-side currents i₁, i₂ and i_{N} forms a partial current of the generator current of the relevant phase. Said generator current of the relevant phase thus forms the summation current of said generator current phase. This is shown in FIG. 2 as summation current is and flows through a generator inductance 234. In this case, in the schematic illustration of FIG. 2, which can also be regarded as an equivalent circuit diagram, the generator 250 is taken into account as voltage source with the voltage VG.

The generator-side voltages V₁, V₂ and V_{N} and the partial currents i₁, i₂ and i_{N} can be detected at a detection point (e.g., ammeter, voltmeter or multimeter) 261, 262 and 263, respectively, and transmitted to the respective control part (e.g., controller) 241-243 or the respective control part 241-243 detects the respective voltage and the respective partial current at the detection point. The control parts 241-243 can then transmit the values detected in this way to a central control system and/or to a control unit.

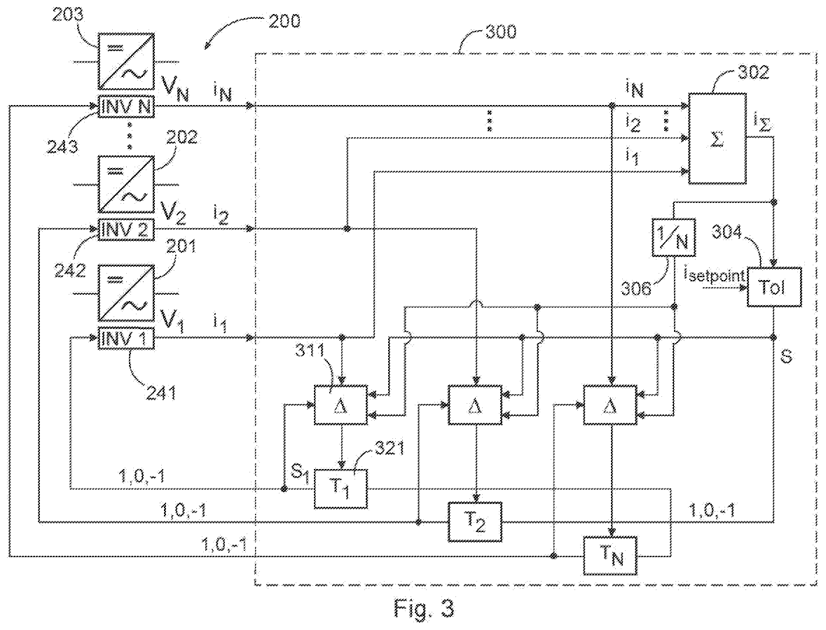

FIG. 3 schematically illustrates in a simplifying manner a possible control concept.

In this case, FIG. 3 uses a sub-rectifier arrangement 200 of a phase, as has been explained in FIG. 2. However, for the sake of clarity, of the sub-rectifier arrangement 200 of a phase, FIG. 3 illustrates only a part of the one illustrated in FIG. 2. In particular, the control parts 241-243 for each sub-rectifier 201-203 are illustrated. These control parts 241-243 detect the generator-side voltages V₁, V₂ and V_{N} and the partial currents i₁, i₂ and i_{N}. These values are passed to a central control system (e.g., central controller) 300, which in this case is delimited schematically by a dashed border.

Of these values, in each case the partial currents i₁, i₂-i_{N} are summed in a summing element (e.g., summing node) 302 and then result in the summation current i_{Σ}. This summation current i_{Σ} may correspond to the summation current is in FIG. 2 or should ideally correspond thereto. However, the summation current is in FIG. 2 in this respect denotes the actual summation current, whereas the summation current i_{Σ} in FIG. 3 is a computation variable, namely the sum of the partial currents i₁, i₂-i_{N}. Where measurement errors or measurement inaccuracies are permitted to be disregarded, the calculated summation current i_{Σ} corresponds to the actual summation current is in FIG. 2.

In any case, said calculated summation current i_{Σ} is input into a modulation block 304. The modulation block 304 uses a tolerance band method in order to modulate a setpoint current iₛₑₜₚₒᵢₙₜ. For this purpose, a tolerance band is placed around said prescribed current iₛₑₜₚₒᵢₙₜ, which is prescribed according to magnitude, frequency and phase, and thus is prescribed as a sinusoidal current Depending on whether the summation current i_{Σ} contacts an upper or lower tolerance limit, a switching signal between 0 and 1, or between 0 and −1, is output. This additionally depends on whether the current that is to be generated is currently positive or negative, to put it clearly.

The result of the modulation block, that is to say of the tolerance band method executed in the modulation block 304, is thus a switching signal that is basically provided for each sub-rectifier. The sub-rectifier is intended to switch the switching voltage V_{S1}, V_{S2} and V_{SN}, respectively, according to the switching signal, namely to the negative value, the positive value or to zero.

Said switching signal that is output by the modulation block 304 can thus switch the switch position in each sub-rectifier 201, 202 or 203. If any circulating currents arise, which for example influence the partial current I1 and the partial current I2, however, this has no effect on the switching signal that is generated by the tolerance band method in the modulation block 304.

As a result, an important target can already be achieved, namely the generation of the summation current by way of parallel-connected sub-rectifiers substantially independently of circulating currents. Furthermore, however, it is proposed to additionally take into account time differences between the individual sub-rectifiers 201-203. Although such consideration can be carried out centrally in a common computation block, for example, this is individually illustrated in FIG. 3 for each sub-rectifier 201-203 for the purposes of illustration. However, the mode of operation explained below is the same for all sub-rectifiers 201-203 in principle. In this respect, this is explained below for the sub-rectifier 201.

The sub-rectifier 201, which in this respect can also be referred to as the first sub-rectifier, transmits the generator-side voltage V₁ and the partial current i₁ thereof to the central control system and these values are also given here to a first propagation time detection block 311. In this respect, a propagation time is detected in the propagation time detection block and a switching time adjustment is determined in a manner depending thereon. The detected switching time adjustment is transferred to the adjustment block 321. The adjustment block 321 essentially delays the switching signal S. The result is an adjusted switching signal S₁. The adjusted switching signal S₁ is furthermore a switching signal that can have the values 1, 0 or −1, which can also be encrypted in another manner, however. However, the adjusted switching signal S₁ is delayed with respect to the unchanged switching signal S.

The propagation time detection block 311 also receives this adjusted switching signal S₁ and the generator-side voltage V₁ and the partial current i₁ of the first sub-rectifier. The propagation time detection block 311 can then recognize when exactly a switching command has been transmitted by taking into account the adjusted switching signal S₁. A switching command can in this respect be one upon which the switching signal changes from 0 to 1 or back or from 0 to −1 or back. This time is then known precisely in the propagation time detection block 311 and this can be compared with the resulting result of the generator-side voltage V₁ and partial current i₁ generated by the first inverter 201. It can then thus be recognized which signal results precisely through this adjusted switching signal. Particularly the temporal behavior of the resulting signals is taken into account here but so is an amplitude or an amplitude profile. In this case, consideration is given to the fact that also only one of the two signals, that is to say only the voltage or only the partial current, are taken into account.

Furthermore, the propagation time detection block 311 takes into account the unchanged switching signal S. From this, it is possible to derive how the overall desired signal should appear.

Furthermore or as an alternative, an average value of the partial currents i₁, i₂ and i_{N} can also be used. In order to calculate this average value, only the calculated summation current i_{Σ} needs to be divided by the number of sub-rectifiers, that is to say N. This is illustrated by the quotient block 306.

In this respect, the propagation time detection block 311 calculates time delays for the switching time adjustment by which the switching signal S is adjusted in order to obtain the adjusted switching signal S₁. These time delays can in this case be different for a rising edge of 0 to 1 than for the again falling edge from 1 to 0. The same applies to the edge of 0 to −1 and from −1 to 0. As a result, not only can delays be provided in order to compensate for propagation time delays but also pulse widths can be changed. A rising edge for example of 0 to 1 and a falling edge back from 1 to 0 thus result in a voltage pulse with a pulse width. If different delay times are provided for the rising edge of 0 to 1 and the falling edge of 1 to 0, the pulse width can be changed as a result.

In this context, the procedure involves the propagation time blocks 312 and 313 and the adjustment blocks 322 and 323 in the same manner for the further sub-rectifiers 202 and 203. The result is then that an adjusted switching signal S₁-S₃ is generated for each sub-rectifier 201-203. Each adjusted switching signal S₁-S₃ can in this case take into account different propagation times and also generate pulses with different widths.

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method for controlling a wind power installation, comprising:
generating, by a generator, current having a plurality of phases;
rectifying and controlling, by an active rectifier, the current, wherein for each phase of the plurality of phases the active rectifier includes:
a plurality of controllable sub-rectifiers, each controllable sub-rectifier of the plurality of controllable sub-rectifiers is associated with a partial inductance;
controlling, by each controllable sub-rectifier of the plurality of controllable sub-rectifiers, a respective partial current of a plurality of partial currents of the phase;
summing the plurality of partial currents of each phase of the plurality of phases to produce a respective summation current of a plurality of summation currents;
detecting, for each phase of the plurality of phases, the summation current of the plurality of summation currents; and
controlling the active rectifier based on the plurality of summation currents of the plurality of phases, the controlling the active rectifier including:
controlling, by each controllable sub-rectifier of the plurality of controllable sub-rectifiers, the respective partial current based on the summation current of the phase associated with controllable sub-rectifier.

2. The method as claimed in claim 1, comprising:
operating the active rectifier according to a hysteresis method, wherein:
a tolerance band having an upper band limit and a lower band limit is set for each summation current of the plurality of summation currents, and
each controllable sub-rectifier of the plurality of controllable sub-rectifiers controls the respective partial current depending on whether the summation current reaches the upper band limit or lower band limit.

3. The method as claimed in claim 2, wherein:
each controllable sub-rectifier of the plurality of controllable sub-rectifiers has at least one switch and is configured to control the respective partial current by switching the at least one switch, and
the switching of the at least one switch is controlled depending on whether the summation current reaches the upper band limit or lower band limit.

4. The method as claimed in claim 1, wherein:
each controllable sub-rectifier of the plurality of controllable sub-rectifiers is associated with a delay time, and
each controllable sub-rectifier of the plurality of controllable sub-rectifiers controls the respective partial current depending on the delay time.

5. The method as claimed in claim 4, wherein each controllable sub-rectifier of the plurality of controllable sub-rectifiers switches the at least one switch after the respective summation current has reached an upper band limit or lower band limit and the delay time has elapsed.

6. The method as claimed in claim 4, wherein the delay time is determined depending on the partial inductance of the controllable sub-rectifier.

7. The method as claimed in claim 1, comprising:
detecting a respective deviation of each partial current of the plurality of partial currents from an average partial current; and
controlling the respective controllable sub-rectifier depending on the respective deviation.

8. The method as claimed in claim 7, wherein controlling the respective controllable sub-rectifier depending on the respective deviation includes determining a delay time depending on the respective deviation.

9. The method as claimed in claim 1, comprising:
determining a dynamic correlation between a switching of a controllable sub-rectifier and a resulting partial current based on a sub-rectifier voltage, a current profile associated with the sub-rectifier voltage and a detected generator inductance of the generator; and
controlling the controllable sub-rectifier depending on the dynamic correlation and the summation current.

10. The method as claimed in claim 9, comprising:
determining a delay time depending on the dynamic correlation; and
controlling, by the controllable sub-rectifier, the switching depending on the delay time.

11. The method as claimed in claim 1, wherein:
a central controller detects the respective summation current, generates a plurality of control signals for the plurality of controllable sub-rectifiers and transmits the plurality of control signals to the plurality of controllable sub-rectifiers to control the plurality of controllable sub-rectifiers.

12. The method as claimed in claim 11, wherein:
switching time adjustments for the plurality of controllable sub-rectifiers are determined and transmitted to the plurality of controllable sub-rectifiers by the central controller, and
propagation times of the transmission the plurality of control signals to the plurality of controllable sub-rectifier are determined and accounted for in the determination of the switching time adjustments.

13. The method as claimed in claim 12, wherein delay times of the plurality of controllable sub-rectifiers and/or the propagation times are stored using a control protocol and used to control the plurality of controllable sub-rectifiers.

14. The method as claimed in claim 1, comprising:
performing, by each controllable sub-rectifier of the plurality of controllable sub-rectifiers, switching in order to generate a voltage pulse, performing the switching include:
triggering the switching to trigger a voltage pulse; and
terminating the switching to terminate the voltage pulse, wherein:
a time interval between the triggering of the switching and the terminating of the switching indicates a pulse width of the voltage pulse, and
different switching time adjustments and different and variable delay times are provided for the triggering of the switching and the terminating of the switching in order to control the pulse width.

15. The method as claimed in claim 1, wherein:
three sub-rectifier arrangements including a sub-rectifier arrangement of a first current phase, a sub-rectifier arrangement of a second phase and a sub-rectifier arrangement of a third current phase and a network-based sub-inverter arrangement form a back-to-back sub-converter,
each back-to-back sub-converter has a common DC link to which the sub-rectifiers of a respective sub-rectifier arrangement rectify and from which the sub-inverter arrangement inverts, and
DC links of a plurality of back-to-back sub-converters are coupled to permit circulating currents via the DC links.

16. A wind power installation, comprising:
a generator configured to generate current having one or more phases;
an active rectifier configured to rectify and control the current, wherein for each phase of the one or more phases, the rectifier includes:
a plurality of controllable sub-rectifiers, each controllable sub-rectifier of the plurality of controllable sub-rectifiers being characterized by a partial inductance, and each controllable sub-rectifier of the plurality of controllable sub-rectifiers being configured to:
control a partial current of a plurality of partial currents of a respective phase of the one or more phases, each phase forming a summation current as a sum of the plurality of partial currents of the phase; and
a controller configured to:
control the active rectifier;
detect the summation current for each phase of the one or more phases; and
control each controllable sub-rectifier of a respective phase depending on the summation current for the respective phase.
